(19) United States
(12) Patent Application Publication
(10) Pub. No.: US 2003/0096058 A1
(43) Pub. Date: May 22, 2003

(54) Design effect fiberglass wallcoverings

(76) Inventors: Thomas Wirycz, Billesholm (SE); Per Edlund, Halmstad (SE); Krister Draxo, Helsingborg (SE)

Correspondence Address: JOHNS MANVILLE INTERNATIONAL, INC., Legal Department, P.O. Box 5108, Denver, CO, 80217, US

(21) Appl. No.: 09/996,454

(22) Filed: Nov. 20, 2001

(51) Int. Cl. B05D 1/38; B05D 5/06

(52) U.S. Cl. 427/178; 427/261; 427/262; 427/287; 428/204; 428/206; 428/906; 442/65; 442/66

(57) ABSTRACT

A glass fiber wall covering is made by sequential application of a chemical dispersion, a hydrophobic coating to selectively create an image for painted effects, and a second image coating which created plastic volumetric images.

### BACKGROUND

The benefits of using fiberglass wall coverings are well known. Fiberglass wall coverings offer fire resistance, easy and uncomplicated handling and flexibility in use. They exhibit good abrasion resistance and appearance following painting. Typically, following adherence of the fiberglass wall covering to a structure, a uniform coating of a solid paint is applied, creating a textured painted wall effect.

Recently, it has become increasing desired to conveniently obtain finished effects different from a solid painted surface. In the absence of using a textured wall covering such as fiberglass fabric, many consumers are opting for a multi-step “effect paint” finish for interior walls. Such painted effects often comprise a multiple coating of paints, together with labor intensive steps which may include specialized rollers, sponges, devices, with accompanying complex techniques. Typically, only the most experienced or professional painter will achieve a desirable outcome.

In the past, many attempts have been made to create decorative images or color pattern of different kind on fiberglass fabrics. GB 2 249 994 A describes applying a colored pattern by a heated roller to a glass fiber fabric treated with a polyvinyl chloride, acrylic or polyester coating having a solids content of between 6 and 35% by weight of dry extracts. The outcome of the process produced a finished glass fabric with a fixed image. Typically, the hot transfer of colored pigments onto a glass fabric at a temperature of between 140° and 210° C. creates a rigid and stiff fabric, not conducive to packaging as a rolled good for later application to a wall.

By reason of the chemical inertness of the base glass material, dyeing techniques are ineffective on such materials. Accordingly, others have attempted prime coated glass textile fiber or fabric with various adherent coatings which are capable of receiving dye substances. U.S. Pat. No. 3,589,934 discloses such a process where glass fibers or fabrics are coated with an interpolymer comprising a non-rubbery interpolymer of a polyunsaturated hydrocarbon monomer and at least one mono-olefin monomer having a single copolymerizable ethylenic group. The prime coating is first cured and then the coated fabric is contacted with an organic dye. U.S. Pat. No. 3,591,408 discloses a process for coloring glass fibers and fabrics wherein the glass fibers are treated with the combination of an amino and/or epoxy silane, its silanol or polysiloxane and a fiber reactive “Procilan” dye or “Procion” dye having groupings that react with the amino or epoxy groups of the organo silicon compound to form an organo silicon compound to form an organo silicon-dye compound that becomes strongly anchored to the glass fiber surfaces with sufficient dye concentration to impart the desired color intensity.

U.S. Pat. No. 2,955,053 issued Oct. 4, 1960 to Roth describes a finished wall covering product. The patent describes a process for first applying a binder in a first treatment bath, followed by one or more coloring baths having pigments contained therein. While providing a colored glass fabric, there is no provision for an effect image.

It is also well know in the art to imprint the desired pattern on wall coverings by various means. EP 0 909 850 A2 describes an imprintable self-adhesive woven glass fabric and a process for applying a thin film of adhesive which may carry a decorative pattern directly on the untreated glass fiber fabric.

EP 0 875 618 describes a fiberglass nonwoven backing printed with ornamental designs by printing hard particle containing adhesives.

EP 0 445 461 describes a wall covering that has a discontinuous printed adhesive coating which creates the desired pattern.

DE 198 11 152 describes an outdoor wall covering which is printed with various kind of materials to create patterns and ornaments.

It has become increasing desired to conveniently obtain volumetric effects different from a standard fiberglass wall covering structure. The state of the art method to create volumetric effects on fiberglass wall covering is the use of glass fiber fabrics which are woven by Jaquard weaving machines. U.S. Pat. No. 6,267,151 B1 describes such Jaquard techniques which are well known for quite a long time. These techniques can only provide fabrics with coarse volumetric effects without fine lines and well defined pictures. The fabrics also require a high density weaving which results in a stiff fabric that normally is hard to handle. Typically, only the most experienced or professional painter will achieve a desirable appearance.

Recently, it has become even more desired to obtain wall coverings with distinct image effects with three-dimensional finish structures. Such plastic effects have not been achieved when using fiber glass fabrics. The invention provides a feasible and economic process to produce an intermediate rolled good product, which when applied to a wall and painted by a consumer, will display a distinct and decorative three-dimensional image effect.

### SUMMARY OF THE INVENTION

It is accordingly an object of the present invention to provide a glass yarn fabric product suitable for subsequent application to walls or structures, which fabric is coated and conditioned such that it exhibits a volumetric image at one of the fabric surfaces, and that a later application of a finished coating or paint results in a desired and selective three-dimensional image effect. The glass fiber fabric has the same properties like standard glass fiber wall coverings, such as excellent fire resistance.

It is another object of the present invention to provide a process for the manufacture of a glass fiber product which process is relatively safe and practical, to produce a designed volumetric image fiberglass wall covering.

According to a preferred embodiment of the present invention, a glass fabric is produced by a process comprising the steps of providing a fiberglass fabric, applying a chemical dispersion to the glass fabric, after drying selectively applying to one side of the fabric a first image coating to a portion of the treated glass fabric, selectively applying a second image coating to a portion of the treated glass fabric, and creating the three-dimensional image pattern by drying the treated glass fabric. The three-dimensional effect becomes particularly distinct after the final painting by the end user.

While the preferred embodiment utilizes fiberglass fabric in woven rolled form, other fiberglass fabrics such as a nonwoven mat may be utilized.

Still other objects, features and attendant advantages of the present invention will become apparent to those skilled in the art upon reading the following detailed description of the preferred embodiments, together with the accompanying drawings.

### BRIEF DESCRIPTION OF THE DRAWINGS

FIG. 1 depicts the process for applying the chemical dispersion, in the preferred method of continuous impregnation.

FIG. 2 depicts a method of applying the first image coating and the second image coating by a rotating screen.

### DETAILED DESCRIPTION OF THE INVENTION

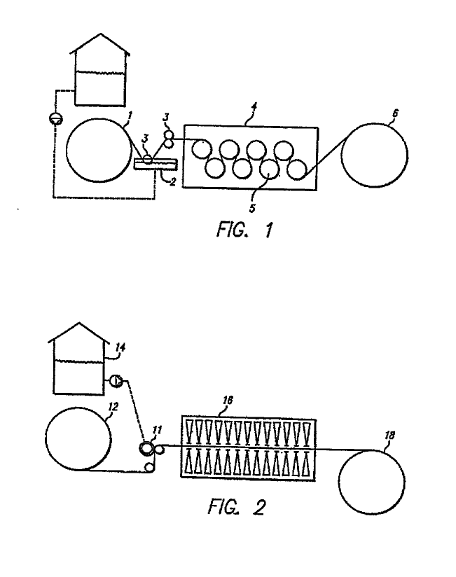

FIG. 1 depicts a process for impregnating a glass fabric. Preferably, the glass fabric is a woven product from fiberglass yarn. The weave is typically a simple pattern, of up to eight shaft. The weave is produced, for example, on Dornier weaving machines, Rapiers or Air-Jets, in typically two to three meter widths for collecting on roll beams of typically 1,500-6,000 meters of untreated woven fiberglass fabric. Many fiberglass yams are possible for use in producing the woven material for use in the present invention. Preferred yarns include, for the warp direction continuous C-glass or E-glass of 9-12 microns, 137-142 texturized with approximately 315-340 ends per meter. An alternative warp yarn is continuous C-glass or E-glass of 6-9 micron, 34-68 tex with 650-680 ends per meter. For the weft direction, a preferred glass is discontinuous spun E-glass or C-glass, 8-11 micron, 165-550 tex with about 170-600 ends per meter. An alternative weft yarn includes continuous volumized E-glass or C-glass of 8-11 micron, 165-550 tex with about 170-600 ends per meter. Relatively flat woven surfaces are preferred, with minimal relief. However, the invention is not limited to certain weave pattern, styles and textures. The present invention is also applicable to nonwoven glass fabrics, such as those mat products produced, for example, by conventional wet-laid processes.

In the process of the present invention, the glass fabric 1, preferably in roll form, is fed to an impregnation bath 2, typically through rollers 3 and conventional conveyance means to contact a bath of a chemical dispersion, or alternatively, for example, a pick up roll may convey the chemicals to at least one of the glass fabric surfaces. Alternatively to the use of rollers 3, rotary screens or flat screens may be used to apply the dispersion to the glass fabric 1. The mixture is supplied to the interior of the two rotating screens and applied to the glass fabric by contact with the rotating screens.

The mixtures used for the impregnation have an affinity for, attracting, adsorbing, or absorbing water. A preferred impregnation mixture consists of those components set out in Table 1 below.

TABLE 1

| | | |
|---|---|---|
| Starch binder | 65-75% | of dry substance |
| Polymeric binder | 20-30% | of dry substance |
| Cross-linker | 2-6% | of dry substance |
| Pigments | 0-20% | of dry substance |

Commercially available starch binder or CMCs (carboxy-methyl cellulose) can be used. Starch binders from potatoes are preferred, but also corn can be used as a starch source. The polymeric binders are preferably copolymers of vinyl acetate and acrylics, e.g. ethylvinyl acetate and styrene acrylics. However, polyvinyl acetate (PVAc) or other polymeric latex binders can also be used.

Cross-linkers are agents reactive with certain functional groups located primary on binder polymer. Cross-linkers preferably are used in a concentration of 3 to 12 percent on a dry basis to improve important characteristics such as film formation, hydrophobicity, wet strength etc. These reactive agents can be either organic and inorganic types, e.g. based on zirconium, urea/formaldehyde or glyoxal derivatives. Zirconium cross-linking agents (e.g. ammoniu m-zirconium-carbonate) are preferred.

The mixture is preferably water based, and has a dry substance percentage of between 3 and 15 weight percent, preferably between about 5.5 and 8 weight percent in the chemical bath. This first impregnation step adds additional volume and opacity to the fabric. Typically 10-60 g/m² of the coating are applied to the wall covering. Besides white pigments such as titanium dioxide, colored pigments can also be added or used to create colored fabrics as well.

Following the impregnation, the fabric may be conveyed to a drying means 4, which in the preferred embodiment of FIG. 1 is depicted as steam heated cylinders 5. Also an air dryer can be used. After drying, the weave is usually cut into desired width, and collected for subsequent secondary treatment, for example, into rolls at a batching stand 6 of between 1,000 and 6,000 meters of treated weave. Alternatively, the subsequent image application step can be a continuous and direct step to the impregnation step.

In FIG. 2, a preferred method of applying the first image coating is depicted. A rotating screen 11, such as available from Stork, may be used to selectively apply a hydrophobic primary image coating to a select portion of the treated glass fabric 12. The rotating screen is preferably laser drilled with a desired image pattern, and chemicals supplied to the interior of the rotating screen. Hydrophobic chemicals 14 are selectively applied to the glass fabric by contact with the rotating screen device. By “hydrophobic”, it is meant a chemical or chemical mixture lacking an affinity for, repelling, or failing to adsorb or absorb water, i.e. the paint. A preferred hydrophobic mixture useful in the primary image coating of the present invention includes a varnish or binder, preferably a clear varnish comprising ethylene vinyl acetate copolymers. Alternatively, the mixture may be any hydrophobic varnish or binder with or without color pigments. A preferred primary image coating consists of those components set out in Table 2 below.

TABLE 2

| | | |
|---|---|---|
| Polymeric Binder | 20-80% | of dry substance |
| Polypropylene Glycole | 0-50% | of dry substance |
| Pigments | 0-25% | of dry substance |
| Rheology Modifier | 0-20% | of dry substance |
| Wax | 0-10% | of dry substance |

The polymeric binders are preferably copolymers of vinyl acetate and acrylics, e.g. ethylvinyl acetate and styrene acrylics. However, polyvinyl acetate (PVAc) or other polymeric latex binders can also be used.

The primary image coating may also contain pigments for image coloring. All kind of pigments which are suitable for the process can be used. Rheology modifiers (Thickener) may be also added to the image coating to improve the processability. Rheology modifiers may be selected from the known group of acrylic thickener, polyurethane thickener or cellulose thickener, etc.

The primary image coating may also contain wax components, e.g. by adding a paraffin wax dispersion to the mixture, to enhance the hydrophobicity of the coating. Small amounts of de-foaming materials based on oil or silica can also be added to the chemical mixture to improve the efficiency of the printing process.

Water based paints or non water based paints like metallic paints are also useful image coatings. When a clear varnish or binder is used, it is preferable to apply an optical whitener for a quality checking ability, whereby the varnish or binder is visible to an ultraviolet observation. The varnishes, binders or paints used, should be hydrophobic when dry. Preferably 0.5-50 g/m² of the image coating is applied to one side of the glass fabric. The mixture has typically a dry substance percentage of between 20 and 70 weight percent, preferably between 30 and 60 weight percent in the chemical bath.

Alternatively to the rotating screen employed in the preferred embodiment, the hydrophobic image chemicals may be applied by a flat screen method, or any other method to selectively place the chemicals on one side of the treated glass fiber surface.

Following chemical applications, the glass fabric, now possessing an image coating, can be stabilized in a drying process using a “spann rahm”, whereby the woven material is “fixed” through aggressive mechanical contacting during drying in the dryer, preferably an air dryer oven 16. The fixing of the weave stabilizes the dimensions of the fabric. Following stabilization and drying, the glass fabric is then preferably collected in a roll at a batching stand 18.

Alternatively, following the application of the primary image coating, the glass fabric is transferred directly on a continuous basis to the subsequent application step wherein the second image coating is applied. Using this preferred method, the fabric can be dried in a dryer as described above or, alternatively, it can be transferred without a drying directly to the subsequent application step.

FIG. 2 also illustrates the preferred method of applying the second image coating. Such application to one side only is on top of the previously applied and optional dried coating. A rotating screen 11, such as available from Stork, may be used to selectively apply a secondary image coating to a select portion of the treated glass fabric 12. The rotating screen is preferably laser drilled with a desired image pattern, and the chemicals of the second chemical mixture are supplied to the interior of the rotating screen. The chemical mixture 14 of the second coating are selectively applied to the glass fabric by contact with the rotating screen.

The secondary image coating contains chemicals or chemical mixtures which expand or chemically react upon the application of heat. Such chemicals, like foaming agents or expandable microspheres are well known and commercially available over many years. Finely dispersed materials which expand upon heating can be used. In particular expandable thermoplastic microspheres are well suited for the image coating. Such microspheres are commercially available (e.g. Expancel®, CASCO Nobel). They consist of a polymer shell encapsulating a blowing agents which are gasified upon heating. When heated, the thermoplastic shell softens resulting in a dramatic increase of the volume of the microspheres. When fully expanded, the volume of the microspheres increases more than 40 times. Such microspheres are mostly used as fillers in polymers and paints.

A preferred chemical mixture useful in the secondary image coating of the present invention consists of those components set out in Table 3 below.

Preferably 0.5-50 g/m² of the image coating is applied to the glass fabric. The mixture has typically a dry substance percentage of between 20 and 70 weight percent, preferably between 30 and 60 weight percent in the chemical bath.

TABLE 3

| | | |
|---|---|---|
| Polymeric latex binder | 20 to 80% | of dry substance |
| Expandable Chemicals | 5 to 40% | of dry substance |
| Polypropylene glycole | 5 to 50% | of dry substance |
| Rheology modifier | 0 to 20% | of dry substance |

The polymeric latex binders are preferably copolymers of vinyl acetate and acrylics, e.g. ethylvinyl acetate and styrene acrylics. However, polyvinyl acetate (PVAc) or other polymeric latex binders can also be used.

The secondary image coating may also contain pigments for image coloring. All kind of pigments which are suitable for the process can be used. Rheology modifiers (Thickener) may be also added to the image coating to improve the processability. Rheology modifiers may be selected from the known group of acrylic thickener, polyurethane thickener or cellulose thickener, etc. In addition small amounts of de-foaming materials based on oil or silica can also be added to the chemical mixture to improve the efficiency of the printing process.

Alternatively to the rotating screen employed in the preferred embodiment, the image coating may be applied by a flat screen method, or any other method to selectively place the chemicals on the treated glass fiber surface.

Following the application of the secondary image dispersion to the fabric surface, the glass fabric, now possessing an additional image coating, must be conveyed to a drying means which in the preferred embodiment of FIG. 2 is depicted as air dryers 16. During the heat treatment the expandable chemicals of the image coating react and cause the coating to expand. Induced by the chemical reaction and the expansion of the coating, a well distinguishable volumetric pattern can be created. The drying process also stabilizes the coating and the created image pattern. After drying, the fabric can be cut into desired widths and lengths, and collected into rolls at batching stand 18.

The drying temperatures and drying times which are needed to fully establish the images depends on the used image coating materials and the mixture compositions. With the preferred composition of Table 2, the fabric must be dried at 140° C. for approx. 240 sec.

The product of the novel process described above is typically supplied to an end user in roll form, for application to a wall or other interior structure. Conventional types of glues can be used to apply the treated glass fabric to a wall or other interior structures. The product of the present invention possesses the same benefits and favorable properties as untreated standard glass fiber wall covering, with the added benefit of a volumetric image effect in a user selected color, combined with a less labor intensive process. The image effect glass wall covering of the present invention results in a higher quality and in a more consistent appearance if compared to other painting methods, in particular when used in small spaces and interior corners.

The product of the present invention can be painted by the end user either with glazing paints to create a three dimensional effect pattern in any color, or with standard paints to create colorful “volume” effects on the walls. By using both paints for different areas of the wall an almost unlimited number of different patterns can be achieved. Therefore the end user can choose the colors and by selecting the paint he can make a personal contribution to the final result and can create individual designs.

The foregoing description of the specific preferred embodiments will fully reveal the general nature of the present invention that others can readily modify or adapt for various applications to such specific embodiments, without departing from the novel generic concept, and therefore such adaptations and modifications would and are intended to be within the scope of equivalents of the disclosed embodiments. The phraseology and terms employed herein are for the purpose of enablement and description and do not limit the scope of the claims.

### EXAMPLE

A glass woven fabric consisting of 139 tex texturized warp yarns with 315 yarns per meter and 250 tex glass staple fiber yarns with 200 yarns per meter is produced and impregnated on both sides with an aqueous chemical mixture according to the invention. 25% of a potato starch and 47% of a acrylic latex binder is used for that mixture. In addition, 6% of a zirconium cross-linker and 22% of a white, titanium oxide based, pigment are added.

After drying the first image coating is applied by using rotary screens to create an image at the fabric surface. The formulation contains, based on dry substance, 90% of polymeric binder, 5% propylene glycole and 2% of a red pigment.

After drying a chemical dispersion is applied by using rotary screens to create an image at the fabric surface. The formulation contains, based on dry substance, 70% polymeric binder, 15% Expancel® and 15% propylene glycole. After heating and drying in an air dryer oven the image (e.g. a colored logo or pattern) develops.

What is claimed is:

1. A process of manufacturing a designed fiberglass wall covering comprising:
(a) providing a fiberglass fabric;
(b) impregnating the glass fabric by applying a chemical dispersion to the glass fabric;
(c) drying the treated glass fabric;
(d) subsequently forming a first image coating on one side of said treated glass fiber fabric by selectively applying a hydrophobic primary image coating to a portion of the treated glass fabric;
(e) subsequently forming a second image coating on said first image coating by selectively applying the coating to a portion of the treated glass fabric, said coating applied from a chemical mixture comprising a polymeric binder and expandable chemicals, with said second coating being capable of creating distinct image pattern upon heating.

2. The process of claim 1 wherein the fiberglass fabric is a woven or non woven fabric.

3. The process of claim 1 wherein the chemical dispersion is applied in a continuous impregnation process.

4. The process of claim 1 wherein the chemical dispersion is water based and comprises starch and a polymeric binder.

5. The process of claim 4 wherein the chemical dispersion comprises also a cross linking agent.

6. The process of claim 1 wherein the chemical dispersion comprises a mixture of potato starch, vinyl acetate ethylene copolymer, and an ammonium zirconium cross-linker.

7. The process of claim 6 wherein the potato starch comprises 65-75%, the vinyl acetate ethylene copolymer 20-30%, and ammonium zirconium cross-linker 2-6% of dry substance total, further wherein the coating is water based and has a dry substance percentage in the chemical bath of between 3 and 15 weight percent.

8. The process of claim 1 wherein the drying of the treated and/or coated glass fabric is accomplished in an air dryer or by contact drying on heated cylinders.

9. The process of claim 1 wherein the selective applying of hydrophobic primary image coating is accomplished with a rotating screen applicator.

10. The process of claim 1 wherein the hydrophobic primary image coating comprises a hydrophobic binder or varnish.

11. The process of claim 10 wherein the binder or varnish comprises ethylene vinyl acetate copolymer.

12. The process of claim 11 wherein the binder or varnish further comprises a thickener and a de-foamer.

13. The process of claim 12 wherein the binder or varnish further comprises a coloring pigment.

14. The process of claim 1 wherein the hydrophobic primary image coating comprises a paint or a water based paint.

15. The process of claim 14 wherein the paint is a metallic paint.

16. A process according to claim 1 wherein said polymeric binder of the second image coating is an acrylic latex binder.

17. A process according to claim 1 wherein said expandable chemicals of the second image coating are thermoplastic microspheres.

18. A process according to claim 1 wherein said chemical mixture of the second image coating also contains rheology modifier and de-foaming agents.

19. A process according to claim 1 wherein said chemical mixture of the second image coating also includes pigments.

20. A process according to claim 1 wherein the application of said chemical mixture of the second image coating is accomplished through the use of a rotating screen applicator.

21. A glass fiber wall covering with a distinct image pattern formed by the process of claim 1.

22. A glass fiber rolled good comprising a fiberglass fabric having applied thereon a secondary volumetric image coating to a portion of the surface of the glass fabric, wherein prior to the secondary volumetric image coating a hydrophobic image coating was applied to a portion of the surface of the glass fabric, wherein the glass fabric was impregnated with a chemical dispersion prior to the hydrophobic primary image coating, whereby the second dried coating exhibits a volumetric image pattern, and whereby when a final coat is applied, selective areas will absorb and resist adsorbents of the final coating to create a plastic image comprising zones of relative less and more color or reflectance.
